(19) United States
(12) Patent Application Publication
(10) Pub. No.: US 2006/0036547 A1
(43) Pub. Date: Feb. 16, 2006

(54) Authentication system, card and authentication method

(76) Inventor: Hiroshi Yasuhara, Kanagawa-ken (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/199,423

(22) Filed: Aug. 8, 2005

(30) Foreign Application Priority Data
Aug. 10, 2004 (JP) 2004-233429 (PAT.
Jul. 25, 2005 (JP) 2005-214332 (PAT.

(51) Int. Cl. G06Q 40/00

(52) U.S. Cl. 705/44

(57) ABSTRACT

Provided are an authentication system, an IC card and an authentication method in which identification information is displayed in association with respective ones of multiple items of authentication information, and authentication information corresponding to identification information that has been selected from multiple items of identification information is acquired, thereby making it possible to select authentication information utilized in authentication. First, the user is requested to input a password for displaying, on a display unit, a list of user-name accounts for display purposes corresponding to respective ones of multiple items of authentication information that have been stored on the IC card. Based upon the password entered, it is determined whether the user has performed an operation to allow display of the list and, with this as a condition, one item of authentication information is allowed to be selected from the multiple items of authentication information stored on the IC card. The selected one item of authentication information is acquired from the IC card and user authentication is carried out.

### FIELD OF THE INVENTION

The present invention relates to an authentication system for authenticating an individual using an external device, a card and an authentication method.

### BACKGROUND OF THE INVENTION

IC cards have started to become widely available in recent years in place of magnetic cards. When an IC card is utilized, a password referred to as a PIN (Personal Identification Number) is necessary when accessing information within the card. Further, an IC card has sophisticated security functions. For example, an IC card has a PIN-based information protection function that makes it impossible to access information if the PIN is entered erroneously a fixed number of times, and an IC card is more difficult to duplicate than a magnetic card or the like. Such IC cards utilizing these sophisticated security functions are now being employed as means for storing personal authentication information or as means for storing information needed in encryption or decryption.

At the present time when a large number of personal authentication systems and the like are in use, a scenario is conceivable in which a single individual will utilize different items of authentication information in the same type of authentication system, such as when one individual possesses different accounts with respect to a plurality of domains. In view of such a scenario, it has become necessary to manage multiple items of authentication information employed in the same type of authentication system used by one individual.

For example, conceivable methods that may be adopted in an instance where multiple items of authentication information are managed utilizing an IC card include a method in which the user is required to possess a number of IC cards and a method in which multiple items of personal information are stored on one IC card. There is prior art relating to a system in which an IC card storing multiple items of personal information is used to expedite an exchange of insurance information between a remote location and a medical facility so as to simplify the maintenance of accurate insurance information and the settlement of medical expenses (e.g., see the specification of Japanese Patent Application Laid-Open No. 2002-230157).

However, in accordance with the method described in-the above-cited patent reference, an item of personal information to be used from among multiple items of personal information in an IC card cannot be designated at will. Accordingly, in a case where multiple items of authentication information have been stored on an IC card and it is possible to freely designate an item of authentication information used in authentication from among these items of authentication information, it would be desirable if one item of authentication information could be selected from among the multiple items thereof while the selectable authentication information is verified.

### SUMMARY OF THE INVENTION

The present invention has been proposed to solve the problems of the prior art and its object is to provide an authentication system, card and authentication method in which identification information is displayed in association with respective ones of multiple items of authentication information, and authentication information corresponding to identification information that has been selected from multiple items of identification information is acquired, thereby making it possible to select authentication information utilized in authentication.

According to the present invention, the foregoing object is attained by providing an authentication system for authenticating a user using authentication information that has been selected from multiple items of authentication information stored in an external device, comprising: a display unit adapted to display multiple items of identification information corresponding to respective ones of the multiple items of authentication information stored on the external device; an acquisition unit adapted to acquire authentication information, which corresponds to identification information that has been selected from the multiple items of identification information, from the external device; and an authentication unit adapted to execute authentication processing using the authentication information that has been acquired by the acquisition unit.

Further, according to the present invention, the foregoing object is attained by providing an authentication system for authenticating a user using authentication information that has been selected from multiple items of authentication information stored on an external device, comprising: a display unit adapted to display multiple items of identification information corresponding to respective ones of the multiple items of authentication information stored on the external device; an input unit adapted to input one item of authentication information, which corresponds to identification information that has been selected from the multiple items of identification information, and new authentication information to which a change is to be made; and an updating unit adapted to update the one item of authentication information, which has been stored on the external device, using the new authentication information that has been input by the input unit.

Further, according to the present invention, the foregoing object is attained by providing an authentication system for authenticating a user using authentication information that has been selected from multiple items of authentication information stored in an external device, comprising: a display unit adapted to display multiple items of identification information corresponding to respective ones of the multiple items of authentication information stored on the external device; an input unit adapted to input one item of authentication information, which corresponds to identification information that has been selected from the multiple items of identification information, and new authentication information to which a change is to be made; and an updating unit adapted to update the one item of authentication information, which has been stored on the external device, using the new authentication information that has been input by the input unit.

Further, according to the present invention, the foregoing object is attained by providing a card removably inserted into the above-described authentication system, comprising: a first storage unit adapted to store the multiple items of authentication information; and a second storage unit adapted to store identification information, which is for display, corresponding to respective ones of the multiple items of authentication information.

Further, according to the present invention, the foregoing object is attained by providing an authentication method for authenticating a user using authentication information that has been selected from multiple items of authentication information stored in an external device, comprising: a display step of displaying on a display unit multiple items of identification information corresponding to respective ones of the multiple items of authentication information stored on the external device; an acquisition step of acquiring authentication information, which corresponds to identification information that has been selected from the multiple items of identification information, from the external device; and an authentication step of executing authentication processing using the authentication information that has been acquired at the acquisition step.

According to the present invention, the authentication method further comprises a second input step of inputting authentication information for acquiring authentication information, which corresponds to identification information that has been selected from the multiple items of identification information, from the external device;

and a second determination step of determining, based upon the authentication information that has been input at the second input step, whether acquisition of the authentication information corresponding to the identification information that has been selected from the multiple items of identification information is allowed; wherein if it has been determined at the determination step that acquisition of the authentication information is allowed, then the authentication information corresponding to the identification information that has been selected from the multiple items of identification information is acquired from the external device.

Further, according to the present invention, the foregoing object is attained by providing an authentication method updating authentication information that has been selected from multiple items of authentication information stored in an external device, comprising: a display step of displaying on a display unit multiple items of identification information corresponding to respective ones of the multiple items of authentication information stored on the external device; an input step of inputting one item of authentication information, which corresponds to identification information that has been selected from the multiple items of identification information, and new authentication information to which a change is to be made; and an updating step of updating the one item of authentication information, which has been stored on the external device, using the new authentication information that has been input at the input step.

Other feature and advantages of the present invention will be apparent from the following description taken in conjunction with the accompanying drawings, in which like references characters designate the same or similar parts throughout the figures thereof.

### BRIEF DESCRIPTION OF THE DRAWINGS

The accompanying drawings, which are incorporates in and constitute a part of the specification, illustrate embodiments of the invention and, together with the description, serve to explain the principle of the invention.

FIG. 1 is a block diagram illustrating the configuration of an authentication system according to an embodiment of the present invention;

FIG. 2 is a diagram illustrating an example of the hardware implementation of an IC card used in the authentication system according to this embodiment of the present invention;

FIG. 3 is a diagram illustrating the essentials of the hardware implementation of client personal computers shown in FIG. 1;

FIG. 4 is a diagram illustrating an example of a file format in an EEPROM of an IC card according to the embodiment illustrated in FIG. 2;

FIG. 5 is a diagram illustrating an example of the internal organization of a user-account list information file shown in FIG. 4 of the IC card according to this embodiment;

FIG. 6 is a diagram illustrating an example of the internal organization of authentication-information storage files shown in FIG. 4 of the IC card according to this embodiment;

FIG. 7 is a flowchart for describing authentication processing in the authentication system according to the embodiment shown in FIG. 1;

FIG. 8 is a flowchart for describing a procedure for inputting authentication information in the authentication system according to the embodiment shown in FIG. 1;

FIG. 9 is a diagram illustrating an input screen presenting a display instructing that a PIN code is to be entered;

FIG. 10 is a diagram illustrating a list of user accounts ,;

FIG. 11 is a diagram illustrating an input screen presenting a display instructing entry of a PIN code for accessing a file corresponding to an identifier associated with a display user name that has been selected; and

FIG. 12 is a diagram illustrating an input screen presenting a display instructing that authentication information is to be entered.

### DETAILED DESCRIPTION OF THE PREFERRED EMBODIMENT

An authentication system according to an embodiment of the present invention and an IC card utilized in this system will be described in detail with reference to the drawings.

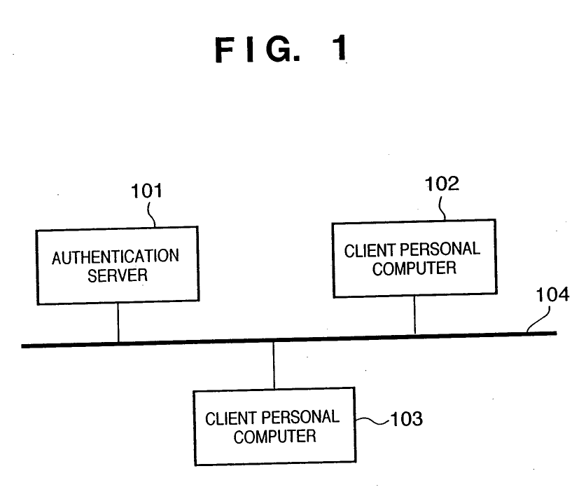

FIG. 1 is a block diagram illustrating the configuration of an authentication system according to an embodiment of the present invention. As shown in FIG. 1, the authentication system according to this embodiment includes an authentication server 101 and client personal computers 102, 103 connected to one another via a network 104. The client personal computer 102 or 103 is capable of performing two types of authentication, namely network authentication by the authentication server 101 and local authentication by the client personal computer 102 or 103 itself.

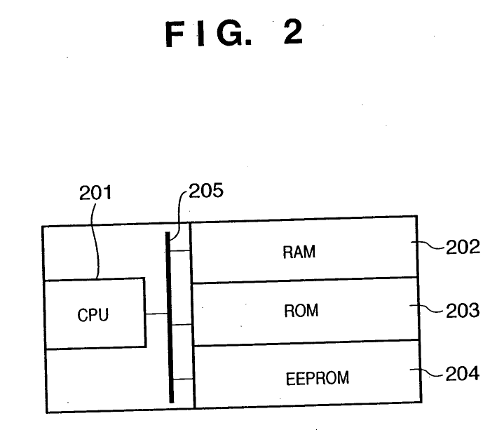

FIG. 2 is a diagram illustrating an example of the hardware implementation of an IC card used in the authentication system according to this embodiment of the present invention. As shown in FIG. 2, a processor (CPU) 201 is connected to a RAM 202, a ROM 203 and an EEPROM 204. The RAM 202 is a memory utilized by the CPU 201 to execute data processing. The ROM 203 stores a program executable by the CPU 201. Various information such as application information is stored in the EEPROM 204.

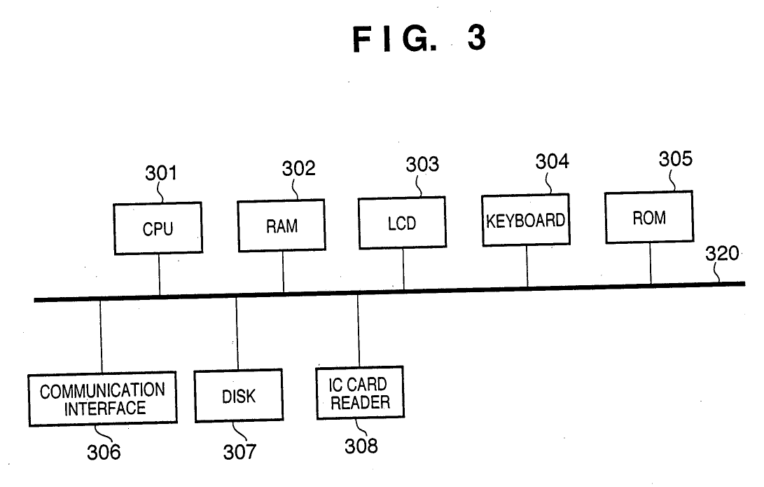

FIG. 3 is a diagram illustrating the essentials of the hardware implementation of the client personal computers 102 and 103 shown in FIG. 1. As shown in FIG. 3, each of the client personal computers 102, 103 includes a CPU 301, a RAM 302, a liquid crystal display (LCD) 303 that displays various information, a keyboard 304, a ROM 305, a communication interface 306, a storage device (disk) 307 such as a hard disk, an IC card reader 308 for reading information that has been stored on the IC card shown in FIG. 2, and a system bus 320 interconnecting these components.

A program for controlling the client personal computer 102 shown in FIG. 1 has been stored in the ROM 305 or disk 307. When necessary, the program is read out to the RAM 302 and is executed by the CPU 301.

Further, the CPU 301 is capable of communicating with an external device, which has been connected to a wired or wireless network, through the communication interface 306. Furthermore, the CPU 301 communicates with the IC card shown in FIG. 2 via the IC card reader 308, senses insertion or withdrawal of the IC card and reads various information that has been stored on the IC card.

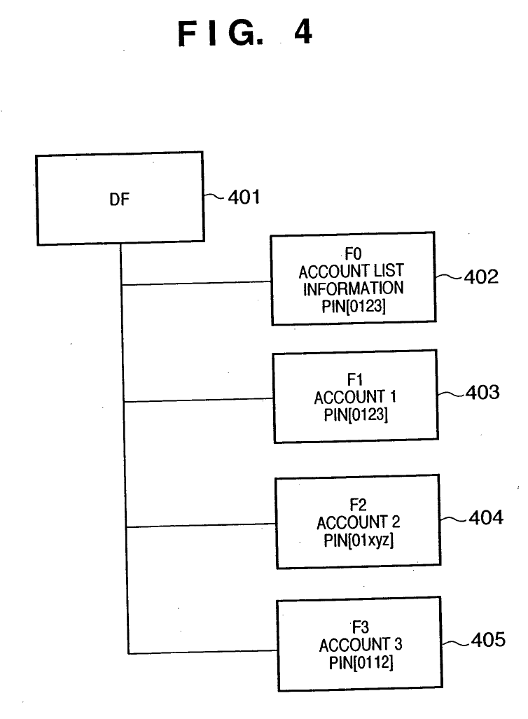

FIG. 4 is a diagram illustrating an example of a file format in the EEPROM 204 of the IC card according to the embodiment illustrated in FIG. 2. A directory file (DF) 401 in the IC card file structure of FIG. 1 is a special-purpose file indicating that authentication information will be stored. The directory file 401 is stored in the EEPROM 204 (which is a non-volatile memory) within the IC card. Further, authentication information and user-account list information, which will be described later, is stored as an elementary file in the directory file 401.

Also shown in FIG. 4 is a file 402 of user-account list information that holds user-account list information, the user-account list information file 402 being identified by an identifier F0 and protected by a PIN “0123”; an authentication-information storage file 403 that holds authentication information related to a User Account 1, the authentication-information storage file 403 being identified by an identifier F1 and protected by a PIN “abcd”; an authentication-information storage file 404 that holds authentication information related to a User Account 2, the authentication-information storage file 404 being identified by an identifier F2 and protected by a PIN “01xyz”; and an authentication-information storage file 405 that holds authentication information related to a User Account 3, the authentication-information storage file 405 being identified by an identifier F3 and protected by a PIN “0112”.

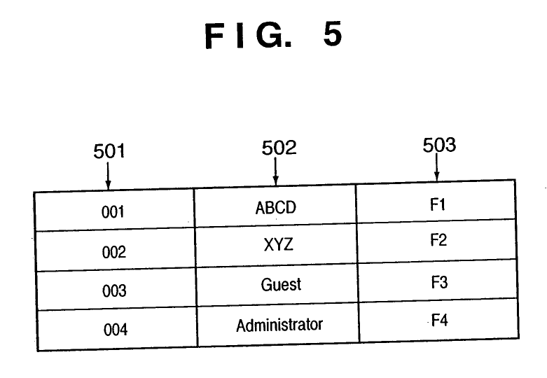

FIG. 5 is a diagram illustrating an example of the internal organization of the user-account list information file F0 (402) shown in FIG. 4 of the IC card according to this embodiment. An index 501 in FIG. 5 serves as identification information for each user account. A user name 502 for display purposes corresponds to a user account. The user name for display may be any identification information, such as a number, for display purposes. Reference numeral 503 denotes an identifier Fx (x=1, 2, 3, . . . )] of an authentication-information storage file holding a user account and password, etc., actually utilized at the time of authentication.

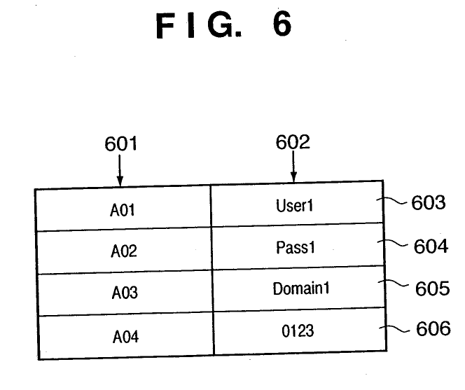

FIG. 6 is a diagram illustrating an example of the internal organization of the authentication-information storage files F1 to F3 shown in FIG. 4 of the IC card according to this embodiment. Shown in FIG. 6 are identifiers 601 of authentication information, authentication information 602 corresponding to respective ones of the plurality of identifiers 601, a user-account name 603, a password 604 corresponding to the user-account name 603, a domain name 605 and a PIN 606 necessary in a case where the authentication information 602 has been updated. This indicates the PIN that is necessary to access user-account list information file in order to update the display user name shown in FIG. 5.

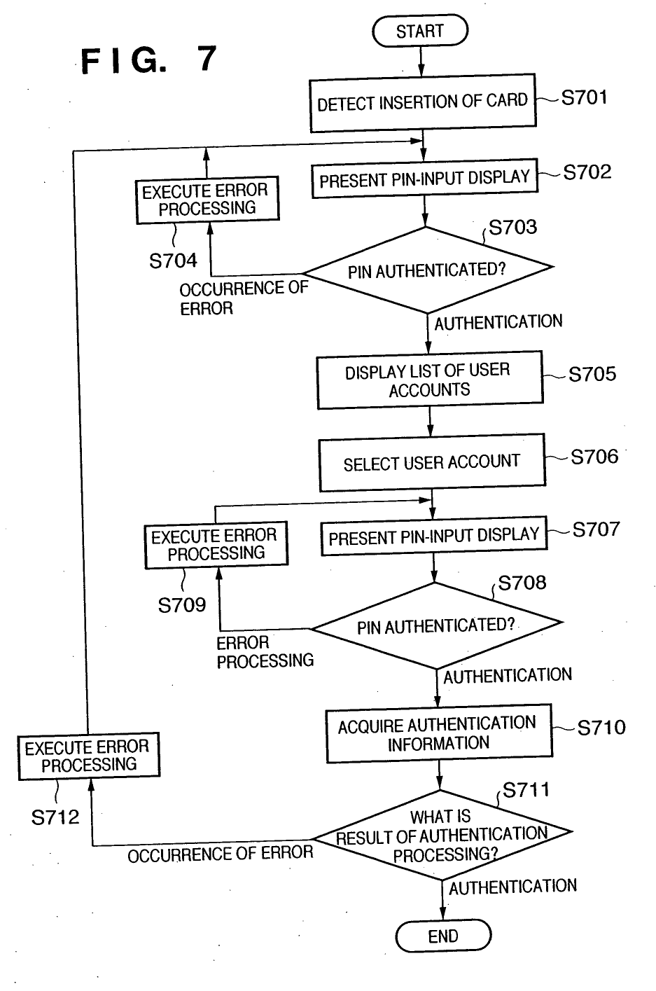

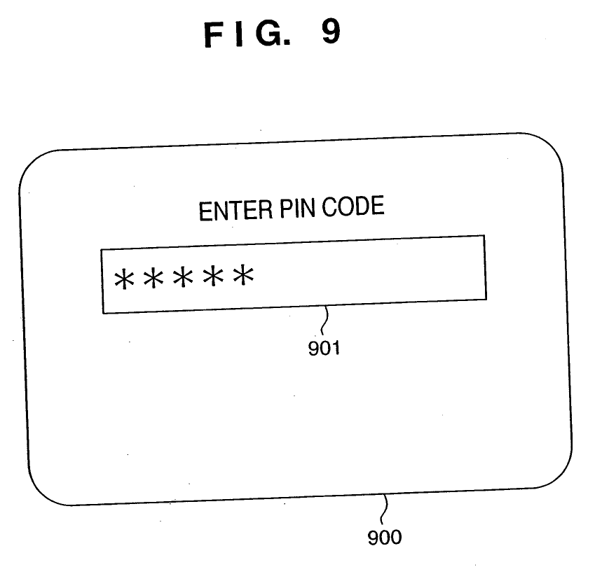

FIG. 7 is a flowchart for describing authentication processing in the authentication system according to the embodiment shown in FIG. 1. First, the client personal computer 103 of the authentication system senses whether the IC card has been inserted into the IC card reader 308 (step S701). It should be noted that the IC card is capable of being removably inserted into the authentication system of this embodiment via the IC card reader 308. Upon sensing that the IC card has been inserted, the client personal computer 103 presents a display (a PIN-input display) that instructs the user to input a PIN code (step S702). The PIN code is necessary in order to display the list of display user names (user accounts) and is required in order to acquire the user-account list information that has been stored in the user-account list information file 402 in the EEPROM 204. FIG. 9 is a diagram illustrating an input screen 900 presenting a display instructing that a PIN code is to be entered. The input screen is displayed on an LCD 303. If the user enters a PIN code using the keyboard 304 or the like, asterisk (*) symbols appear in a box 901. It may also be so arranged that the entered PIN code itself is displayed instead of the asterisks.

After the PIN code is entered, the client personal computer 103 transmits the entered PIN code to the IC card in order that the entered PIN code may be authenticated, and the IC card compares the received PIN code and the PIN code that corresponds to the user-account list information (S703). If the result is occurrence of an authentication error, or in other words, if the entered PIN code and the PIN code corresponding to the user-account list information do not match, the IC card so notifies the client personal computer 103 and the client personal computer 103 presents an error display and executes error processing (step S704). Control thenceforth again transitions to the PIN-input display step (step S702). On the other hand, if the entered PIN code is authenticated as being correct at step S703, or in other words, if the entered PIN code and the PIN code corresponding to the user-account list information match, the IC card transmits the user-account list information, which has been stored in the user-account list information file 402, to the client personal computer 103 and the client personal computer 103 acquires this user-account list information and displays the list of user accounts (step S705).

Authentication information of each user account is not displayed as is in the list of user accounts. Instead, the display user names that are in one-to-one correspondence with the user accounts are displayed.

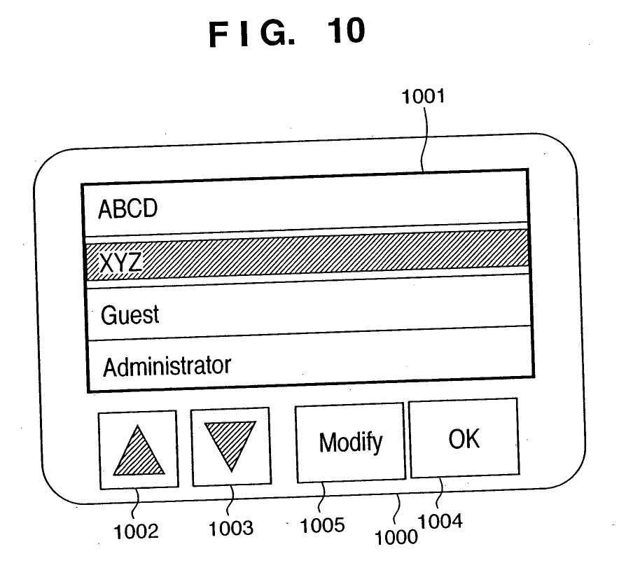

This makes it possible to prevent a third party from stealing a glance at authentication information. FIG. 10 illustrates a list 1001 of user accounts. Here a user-account selection screen 1000 is displayed on the LCD 303. The user presses a button 1002 or 1003 to select the desired user account and then presses an OK button 1004. In the example of FIG. 10, a user account corresponding to a display user name “XYZ” has been selected. If the user wishes to change the content of a user account, then the user presses a button 1005.

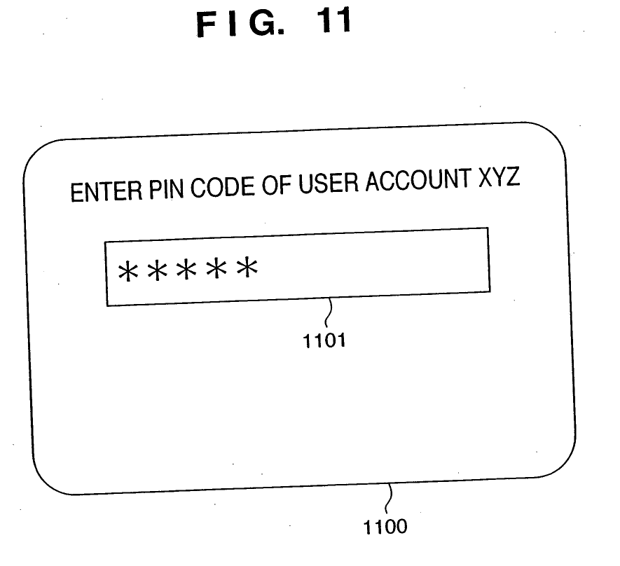

If a specific user account is selected by the 25 user from the user accounts displayed in list form at the user-account list display step (S705), and if the OK button 1004 is pressed, then the client personal computer 103 recognizes the display user name, which has been selected by the user, in order that the particular user account selected by the user may be determined (step S706). The client personal computer 103 then presents a display (a PIN-input display) that instructs the user to input a PIN code for accessing the file identifier 503 that corresponds to the display user name that has been selected (step S707). FIG. 11 is a diagram illustrating an input screen 1100 presenting a display instructing entry of a PIN code for accessing a file corresponding to the identifier 503 associated with a display user name that has been selected. The input screen 1100 is displayed on the LCD 303. Here the input screen 1100 is prompting the user to input the PIN code that corresponds to user account XYZ. If the user inputs the PIN code using the keyboard 304, etc., asterisk (*) symbols appear in box 901. It may also be so arranged that the entered PIN code itself is displayed instead of the asterisks.

For the purpose of performing authentication of the entered PIN code (PIN authentication), the client personal computer 103 transmits the entered PIN code to the IC card, and the IC card compares the received PIN code and the PIN code that has been stored in the authentication-information storage file of the user account that has been selected by the user (step S708). If the result is occurrence of an authentication error, or in other words, if the entered PIN code and the PIN code corresponding to the user account do not match, the IC card so notifies the client personal computer 103 and the client personal computer 103 presents an error display and executes error processing (step S709). Control thenceforth again transitions to the PIN-input display step (step S707). On the other hand, if the PIN code entered at step S707 is authenticated as being correct at the PIN authentication step (step S708), or in other words, if the entered PIN code and the PIN code corresponding to the user account match, control proceeds to step S710 to acquire the authentication information.

At the authentication-information acquisition step (step S710), the IC card transmits information shown in FIG. 6 such as the user-account name 603 and the password 604 corresponding to this account to the client personal computer 103 as authentication information that corresponds to the selected user account. The client personal computer 103 acquires this authentication information. The client personal computer 103 then executes authentication processing based upon the acquired user-account name 603 and password 604 (step S711). If network authentication has been executed as the authentication processing, then the client personal computer 103 transmits the acquired user-account name 603 and password 604 to the authentication server 101 and the result of authentication by the authentication server 101 is received. If local authentication has been executed as the authentication processing, then the client personal computer 103 performs authentication by comparing the acquired user-account name 603 and password 604 with information that has been stored in the database of the client personal computer 103. If an authentication error occurs at the authentication processing step (step S711), the client personal computer 103 presents an error display and executes error processing is executed (step S712). Control thenceforth proceeds to step S702, where the PIN-input display is presented for displaying the user-account list. On the other hand, if authentication processing succeeds at the authentication processing step (step S711), then authentication processing is exited. It should be noted that the above-described processing is the same also in a case where these operations are performed by the client personal computer 102.

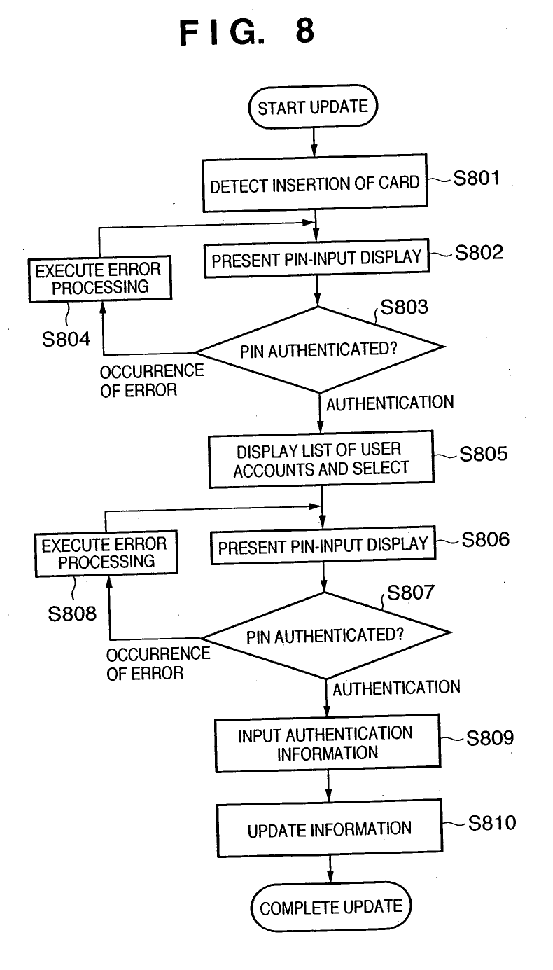

FIG. 8 is a flowchart for describing the procedure of processing for inputting authentication information in the authentication system according to the embodiment shown in FIG. 1. First, the client personal computer 103 senses whether the IC card has been inserted into the IC card reader 308 (step S801). Upon sensing that the IC card has been inserted, the client personal computer 103 presents a display that instructs the user to input a PIN code that is necessary to acquire the user-account information list file 402 in order to display the list of user accounts (step 802). At the PIN-input display step (step S802), the client personal computer 103 displays an input screen identical with that of FIG. 9.

After the PIN code is entered at the PIN-input display step (step S802), the client personal computer 103 transmits the entered PIN code to the IC card in order that the entered PIN code may be authenticated, and the IC card compares the received PIN code and the PIN code that corresponds to the user-account list information (S803). If the result is occurrence of an authentication error at the PIN authentication step (step S803), or in other words, if the entered PIN code and the PIN code corresponding to the user-account list information do not match, the IC card so notifies the client personal computer 103 and the client personal computer 103 presents an error display and executes error processing (step S804). Control thenceforth again transitions to the PIN-input display step (step S802). On the other hand, if the entered PIN code is authenticated as being correct at the PIN authentication step (step S803), or in other words, if the entered PIN code and the PIN code corresponding to the user-account list information match, the IC card transmits the user-account list information file 402 to the client personal computer 103 and the client personal computer 103 acquires the user-account list information file 402 and displays the list of user accounts (step S805). The client personal computer 103 displays a screen identical with that of FIG. 10 at step S805. If the user wishes to enter authentication information, then the user presses the button 1002 or 1003 to select the desired user account and then presses- the button 1005.

In a case where a user account to be updated or written in has been selected by the user from the list of user accounts at the user-account list display and selection step (step S805), and if the button 1005 has been pressed, then the client personal computer 103 presents a display that instructs the user to input a PIN code for accessing the file of the identifier that corresponds to the user account that has been selected (step S806). At the PIN-input display step (step S806), the client personal computer 103 displays an input screen identical with that of FIG. 11.

After the PIN code is input at the PIN-input display step (step S806), the client personal computer 103 transmits the entered PIN code to the IC card for the purpose of performing authentication of the entered PIN code (PIN authentication), and the IC card compares the received PIN code and the PIN code that has been stored in the authentication-information storage file of the user account that has been selected by the user (step S807). If the result is occurrence of an authentication error at the PIN authentication step (step S807), or in other words, if the entered PIN code and the PIN code corresponding to the user account do not match, the IC card so notifies the client personal computer 103 and the client personal computer 103 presents an error display and executes error processing (step S808). Control thenceforth again transitions to the PIN-input display step (step S806).

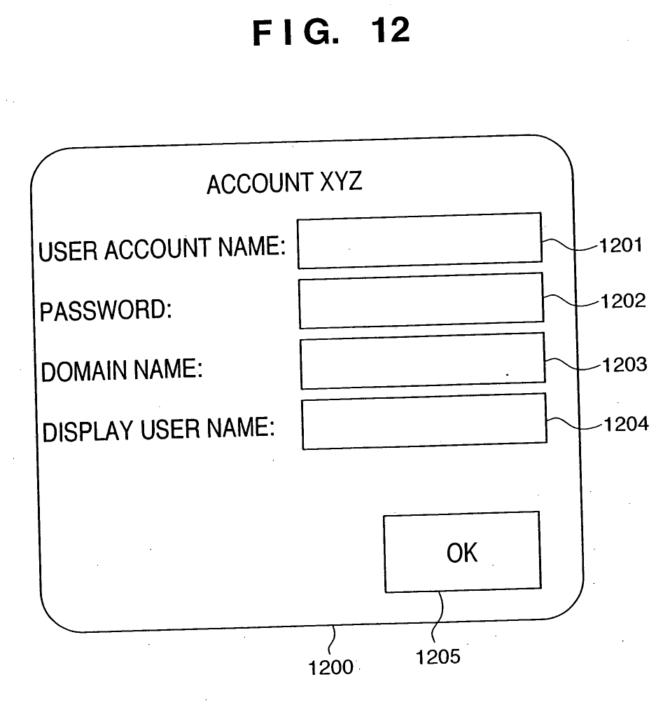

On the other hand, if the PIN code entered at step S707 is authenticated as being correct at the PIN authentication step (step S807), or in other words, if the entered PIN code and the PIN code corresponding to the user account match, then the client personal computer 103 presents a display instructing the user to input authentication information (step S809). FIG. 12 is a diagram illustrating an input screen 1200 presenting a display instructing that authentication information is to be entered. This input screen is displayed on the LCD 303. Using the keyboard 304, etc., the user enters a user account name, password and domain name in boxes 1201, 1202 and 1203, respectively. The user further enters the display user name, which is displayed in the list of user accounts, in box 1204. If the OK button 1205 is pressed, the client personal computer 103 sends the IC card the user account name, password, domain name and display user name that were entered at the authentication-information input step (step S809). The IC card writes the value of each item to the authentication-information storage file corresponding to the user account selected at the user-account list display and selection step (S805). Further, the IC card utilizes the PIN code 606 to update the display user name (step S810) of the user-account list information by the display user name that was entered at the authentication-information input step (step S809).

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

In accordance with the present invention, identification information is displayed as a list in association with multiple items of authentication information that have been stored on a card (e.g., an IC card), and authentication information corresponding to identification information that has been selected from the list is acquired, thereby making it possible to select authentication information utilized in authentication.

Further, in accordance with the present invention, it is possible to perform user authentication that utilizes a single card storing multiple items of authentication information capable of being used in the same type of authentication system, and it is possible to alleviate the burden of an individual possessing a number of cards as means for managing authentication information.

Furthermore, the present invention is such that in the case of authentication information in which multiple items of authentication information used in the same type of authentication system have been assigned to respective ones of a plurality of users, one card can be shared by a plurality of individuals and personal authentication can be performed using accounts that differ from one another.

As many apparently widely different embodiments of the present invention can be made without departing from the spirit and scope thereof, it is to be understood that the invention is not limited to the specific embodiments thereof except as defined in the appended claims.

Claim of Priority

This application claims priority from Japanese Patent Applications No. 2004-233429 filed on Aug. 10, 2004 and No. 2005-214332 filed on Jul. 25, 2005, the entire contents of which are hereby incorporated by reference herein.

What is claimed is:

1. An authentication system for authenticating a user using authentication information that has been selected from multiple items of authentication information stored in an external device, comprising:
a display unit adapted to display multiple items of identification information corresponding to respective ones of the multiple items of authentication information stored on the external device;
an acquisition unit adapted to acquire authentication information, which corresponds to identification information that has been selected from the multiple items of identification information, from the external device; and
an authentication unit adapted to execute authentication processing using the authentication information that has been acquired by said acquisition unit.

2. The system according to claim 1, further comprising:
an input unit adapted to input authentication information for displaying the identification information; and
a determination unit adapted to determine whether display of the identification information is allowed based upon the authentication information that has been input from said input unit;
wherein if it has been determined that display of the identification information is allowed, said display unit displays the identification information.

3. The system according to claim 1, further comprising:
a second input unit adapted to input authentication information for acquiring authentication information, which corresponds to identification information that has been selected from the multiple items of identification information, from the external device; and
a second determination unit adapted to determine, based upon the authentication information that has been input by said second input unit, whether acquisition of the authentication information corresponding to the identification information that has been selected from the multiple items of identification information is allowed;
wherein if it has been determined that acquisition of the authentication information is allowed, said acquisition unit acquires authentication information, which corresponds to the identification information that has been selected from the multiple items of identification information, from the external device.

4. An authentication system for updating authentication information that has been selected from multiple items of authentication information stored in an external storage device, comprising:
a display unit adapted to display multiple items of identification information corresponding to respective ones of the multiple items of authentication information stored on the external device;
an input unit adapted to input one item of authentication information, which corresponds to identification information that has been selected from the multiple items of identification information, and new authentication information to which a change is to be made; and
an updating unit adapted to update the one item of authentication information, which has been stored on the external device, using the new authentication information that has been input by said input unit.

5. The system according to claim 2, wherein the authentication information that has been input by said input unit is a PIN code for a card.

6. A card removably inserted into the authentication system set forth in claim 1, comprising:
a first storage unit adapted to store the multiple items of authentication information; and
a second storage unit adapted to store identification information, which is for display purposes, corresponding to respective ones of the multiple items of authentication information.

7. An authentication method for authenticating a user using authentication information that has been selected from multiple items of authentication information stored in an external device, comprising:
a display step of displaying on a display unit multiple items of identification information corresponding to respective ones of the multiple items of authentication information stored in the external device;
an acquisition step of acquiring authentication information, which corresponds to identification information that has been selected from the multiple items of identification information, from the external device; and
an authentication step of executing authentication processing using the authentication information that has been acquired at said acquisition step.

8. The method according to claim 7, further comprising:
an input step of inputting authentication information for displaying the identification information; and
a determination step of determining whether display of the identification information is allowed based upon the authentication information that has been input;
wherein if it has been determined that display of the identification information is allowed, the identification information is displayed at said display step.

9. The method according to claim 7, further comprising:
a second input step of inputting authentication information for acquiring authentication information, which corresponds to identification information that has been selected from the multiple items of identification information, from the external device; and
a second determination step of determining, based upon the authentication information that has been input at said second input step, whether acquisition of the authentication information corresponding to the identification information that has been selected from the multiple items of identification information is allowed;
wherein if it has been determined that acquisition of the authentication information is allowed, authentication information, which corresponds to the identification information that has been selected from the multiple items of identification information, is extracted from the external device at said acquisition step.

10. An authentication method for updating authentication information that has been selected from multiple items of authentication information stored in an external device, comprising:
a display step of displaying on a display unit multiple items of identification information corresponding to respective ones of the multiple items of authentication information stored in the external device;
an input step of inputting one item of authentication information, which corresponds to identification information that has been selected from the multiple items of identification information, and new authentication information to which a change is to be made; and
an updating step of updating the one item of authentication information, which has been stored on the external device, using the new authentication information that has been input at said input step.

11. A program for causing a computer to execute the authentication method set forth in claim 7.

12. A computer-readable recording medium storing the program set forth in claim 11.
